(19) United States
(12) Patent Application Publication
(10) Pub. No.: US 2007/0142117 A1
(43) Pub. Date: Jun. 21, 2007

(54) Shaft to socket connection having an interference fit

(75) Inventors: Antonio P. Centi, Grosse Ile, MI (US); Wee Tzee Gam, Troy, MI (US)

Correspondence Address: MACMILLAN, SOBANSKI & TODD, LLC, ONE MARITIME PLAZA-FIFTH FLOOR, 720 WATER STREET, TOLEDO, OH, 43604, US

(73) Assignee: Lear Corporation

(21) Appl. No.: 11/314,488

(22) Filed: Dec. 21, 2005

(51) Int. Cl. F16C 3/00

(52) U.S. Cl. 464/179

(57) ABSTRACT

A shaft having an end adapted to be inserted in an opening of a socket for transmitting rotational forces between the shaft and the socket. The end comprises a first portion defining a first axis and having a predetermined first cross section generally complementary to the socket opening, and a second portion connected to the first portion and having a second cross section similar to the first cross section. The second portion is axially offset from the first portion to cause an interference fit when the end is inserted in the socket opening.

### BACKGROUND OF THE INVENTION

This invention relates generally to a connection between the end of a rotatable shaft and a socket, and particularly to an interference fit connection for the end of a flexible shaft in a vehicle power seat adjuster.

Most vehicle seats, particularly in passenger vehicles, are generally provided with adjustment mechanisms to allow a seat occupant to position the seat for optimal comfort and convenience. To accomplish this, vehicle seats are mounted on a seat support frame that is mounted on spaced apart track assemblies. A power seat adjuster can be used to control a motor for operating a mechanism that can move the seat on the tracks. Generally, the typical power seat adjuster can be operated to adjust the seat along multiple axes, including fore and aft; front elevation; and rear elevation.

A drive mechanism for operating the power seat adjuster typically includes an electric motor which bi-directionally rotates a pair of drive shafts extending outward from the motor to a gear assembly or box mounted on each upper track. A transmission drive block containing a gear mechanism is fixedly mounted to each lower track and receives a drive shaft into the gear mechanism of the transmission to cause reciprocal horizontal movement of the upper track and the attached seat support frame relative to the lower track that is fixed to the vehicle when the drive motor is activated. While the use of this drive shaft, motor and gear box arrangement has proven to work for its intended purpose, certain problems still exist. One such problem is that excessive noise and/or vibration may be generated where the drive shaft ends interface with the gear mechanism. This noise and/or vibration are often generated by a loose fit of the ends of the drive shaft with the gear mechanism. Therefore, improvements between the interface of the drive shaft and the gear mechanism to minimize the vibration and noise generated by the interface have been proposed by the prior art. One such example of an improvement to the drive shaft is shown and described in assignee's commonly owned U.S. Pat. No. 6,533,235, the contents of which are hereby incorporated by reference. In this improvement, the end portion of the drive shaft that interfaces with the gear mechanism is twisted about a central axis to provide an interference fit between the drive shaft and the gear. It would also be desirable to develop alternative improvements for improving the fit between the drive shaft and gear mechanism as well.

### SUMMARY OF THE INVENTION

The present invention relates to an improved shaft to socket connection between a drive shaft and gear mechanism. The connection includes a shaft having an end adapted to be inserted in an opening of a socket for transmitting rotational forces between the shaft and the socket. The end of the shaft includes a first portion defining a first axis, and that has a predetermined first cross section generally complementary to the socket opening. The end of the shaft also includes a second portion connected to the first portion, the second portion having a second cross section similar to the first cross section. The second portion is axially offset from the first portion such that an interference fit is created when the end of the shaft is inserted in the socket opening.

In a preferred embodiment, the shaft and the socket are components of a transmission assembly for a power seat adjuster for a vehicle seat. The shaft is preferably flexible, with the first and second cross sections of the end of the shaft having a polygonal, and more preferably square, cross sectional shape. Where the first and second predetermined cross section are square, the square cross section of the first portion preferably defines a diagonal extending between the two opposite corners of the square, and the second portion is preferably axially offset from the first portion along that diagonal. Preferably, the first and second portions of the shaft are integrally formed, and the first portion is connected to a flexible main shaft portion having a main rotational axis coaxial with the first axis of the first cross section.

The end portion may also have a third portion, with the first portion being connected between the main shaft portion and the second portion, and the second portion being connected between the first portion and the third portion. Preferably, the third section also has a polygonal, and more preferably a square, cross sectional shape, that is similar to the cross-sectional shape of the first portion. The third portion is also preferably axially aligned with the first portion, and both the first and third portions remain preferably coaxial with the main rotational axis of the main portion. Where the first predetermined cross section is square, the first cross section preferably defines a diagonal extending between the two opposite corners of the square, and the second portion is preferably axially offset from the first portion and the third portion along that diagonal.

Other advantages of this invention will become apparent to those skilled in the art from the following detailed description of the invention, when read in light of the accompanying drawings.

### BRIEF DESCRIPTION OF THE DRAWINGS

FIG. 1 is a perspective view of a vehicle seat supported on an adjustable seat track assembly.

FIG. 2 is a perspective view of a vehicle seat track assembly including a vehicle seat adjuster.

FIG. 3 is a partially exploded view of a flexible shaft having the tight fit feature of the present invention and transmission drive block assembly used with the vehicle seat adjuster.

FIG. 4 is a sectional view of the flexible shaft and transmission drive block assembly showing the end of the flexible shaft prior to insertion into the worm gear of the transmission drive block assembly. The flexible shaft is shown in elevation.

FIG. 5 is a sectional view of the end of the flexible shaft inserted into the worm gear of the transmission drive block assembly. The flexible shaft is shown in elevation.

FIG. 6 is a sectional view taken along Line 6-6 of FIG. 5 that illustrates the fit of the raised tight fit portion of the flexible shaft within the opening of the worm gear of the transmission drive block assembly.

FIG. 7 is a sectional view taken along Line 7-7 of FIG. 5 that illustrates the fit of the flexible shaft within the opening of the worm gear of the transmission drive block assembly.

### DETAILED DESCRIPTION OF THE INVENTION

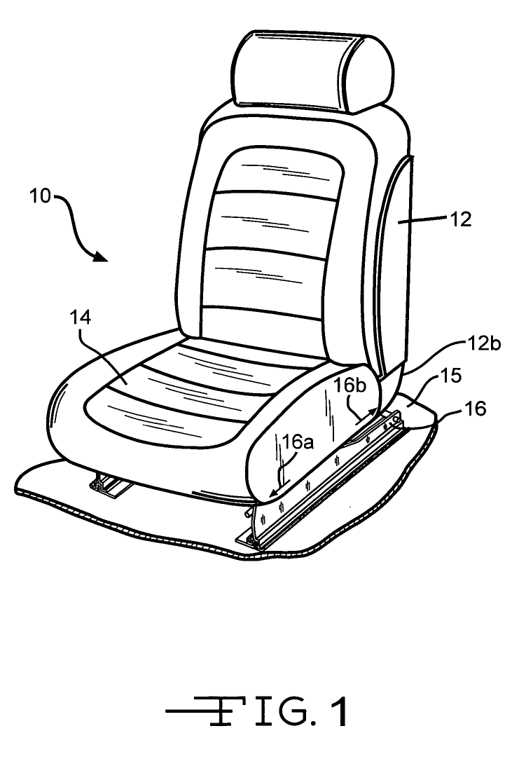

Referring now to the drawings, there is illustrated in FIG. 1 a vehicle seat indicated generally at 10. The vehicle seat 10 has a seat back 12 and a seat bottom 14. The seat bottom 14 can be slidably mounted relative to the vehicle frame, or floor 15, by a seat track adjuster or assembly 16. The seat track assembly 16 can be connected to the vehicle floor 15 or to any suitable portion of the vehicle, such as a vehicle frame member, by any suitable means, such as by bolts or threaded fasteners. The seat track assembly 16 has first and second portions movable relative to each other for moving the seat 10 relative to the floor 15 of the vehicle. The first portion is operatively connected to the floor 15 of the vehicle, or any other structural member, and the second portion is operatively connected to the seat 10. This allows the vehicle seat 10 to slidably move in a fore 16a and aft 16b direction relative to the vehicle floor 15 such that a seat occupant can position the seat 10 a desired distance from the vehicle instrument panel, steering wheel, and foot pedals (not shown) or position the seat 10 for maximum comfort and convenience. Preferably, the vehicle seat 10 has a pair of seat track assemblies 16, one for each side of the seat 10. It is understood, however, that the seat 10 can include any number of seat track assemblies 16, such as a single seat track assembly 16 that would preferably be located near the center of the seat bottom 14. It should also be understood that the seat track assembly 16 may be oriented in a position other than that shown in the figures. It can be appreciated, additionally, that the seat can be moved along multiple axes such as, but not limited to: 1) fore and aft; 2) front elevation; and 3) rear elevation.

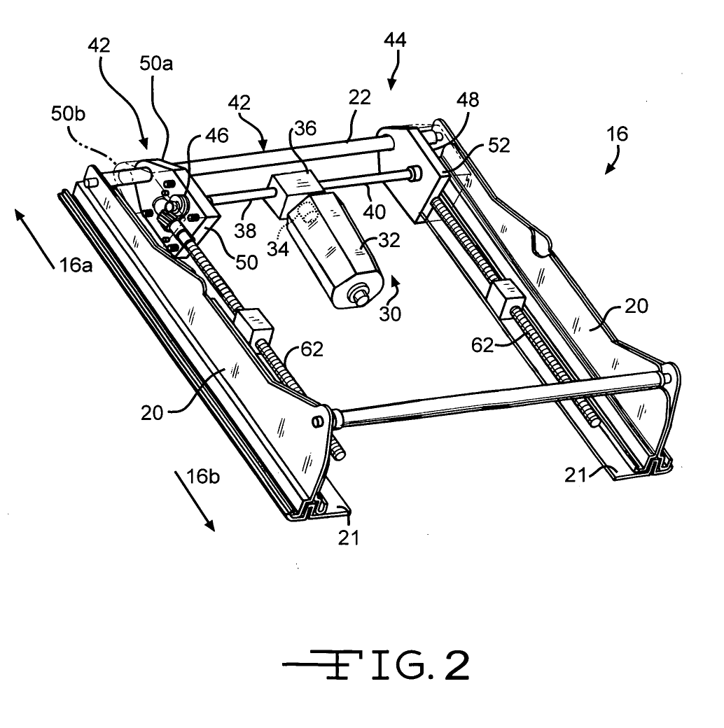

FIG. 2 illustrates an example of a seat adjuster 16 that may use the shaft of the present invention. It will be appreciated that the illustrated seat adjuster 16 is, in large measure, conventional in the art and is intended merely to illustrate one environment in which this invention may be used. Thus, the scope of this invention is not intended to be limited for use with the specific structure for the seat adjuster 16 illustrated in FIG. 2. On the contrary, as will become apparent below, this invention may be used with any style or type of seat adjuster or other mechanically driven device for the purposes described below. The seat adjuster 16 includes a pair of generally parallel, spaced apart upper tracks 20. The upper tracks 20 engage with and slide relative to lower tracks 21 to provide fore and aft directional movement 16a, 16b of the seat. The lower tracks 21 are fixedly mounted relative to the floor 15 of the vehicle in which the seat 10 is installed. The upper tracks 20 preferably include a plurality of rods 22 and 24 that connect the upper tracks to each other. The ends of the rods 22 and 24 can be rotatably mounted on the upper tracks 20 and can be used for elevational movement of the seat bottom relative to the seat tracks. However, for the purpose of clarity, a seat elevation mechanism is not shown or described in detail herein.

The seat adjuster 16 further includes a motor assembly, indicated generally at 30. The motor assembly 30 includes an electric motor 32 which drives an output shaft 34 connected to a gear box 36. The motor 32 is preferably a reversible drive motor in that it is operable to rotate the output shaft 34 in either of the rotational directions. A pair of driven shafts 38 and 40 are connected to the gear box 36. The gear box 36 rotatably couples the output shaft 34 to both the driven shafts 38 and 40. The rotatable coupling of the shafts 34, 38, and 40 can be a one-to-one ratio or can have any other suitable relationship. The motor assembly 30 is shown as having a single motor 32 with two drive shafts 38 and 40 connected thereto. It can be appreciated, however, that a pair of motors (one for each transmission assemblies 42 and 44) could also be used. In such an embodiment, the output shafts of the motors could drive the threaded shafts 38, 40 without the use of a ninety-degree gear box 36.

The seat adjuster 16 also includes a pair of transmission assemblies 42 and 44 which are connected to the driven shafts 38 and 40, respectively. The transmission assembly 42 generally houses a transmission 46. In a similar manner, the transmission assembly 44 houses a transmission 48. The transmission assemblies 42 and 44 can be configured to include a single transmission or any number of transmissions. The transmissions 46 and 48 generally control the fore and aft position of the seat bottom 12, but it will be appreciated that any number of transmissions could be used to control axes of adjustment other than those axes that are specifically identified herein.

The transmission 46 and 48 are shown in FIG. 2 as being positioned within housings 50 formed by a pair of connected blocks 50a and 50b. The transmission assemblies 42 and 44 are similar in function and structure, therefore, the portion of the invention as shown in FIGS. 2 and 3 are described with respect to only one of the pair of transmission assemblies 42 and 44. It should also be appreciated that any suitable transmission assembly can be used in conjunction with the present invention. Referring now to FIG. 3, there is illustrated a partially exploded view of the transmission assembly 42. The transmission assembly 42 includes a housing 50 having a pair of blocks 50a and 50b which cover the transmission 46. The housing 50 can be made of any suitable material and is preferably composed of two separate parts joined together. The housing 50 is preferably generally fixed and does not rotate. Additionally, the housing 50 is preferably mounted with the upper track 20 for movement (fore and aft) therewith.

As shown in FIG. 3, the transmission assembly 42 includes an adapter 56 for operatively connecting the transmission 46 to the drive shaft 38 of the present invention. The drive shaft 38 is preferably a flexible shaft, although it will be appreciated that any other suitable connecting shaft may be used as well. The adapter 56 is connected with a socket for transmitting rotational forces between the shaft 38 and the socket. In the illustrated embodiment, the socket is a threaded worm gear 58. It will be appreciated, however, that the socket may be any suitable component for transmitting rotational forces between the drive shaft 38 and the socket. The worm gear 58 extends from the adapter 56 and into the housing 50. The shaft 38 is inserted through the adapter 56 and into an opening 64 in the worm gear 58. The opening 64 of the worm gear 58 is configured to have a cross sectional shape corresponding to the cross sectional shape of an end portion, indicated generally at 38b, of the shaft 38.

The worm gear 58 and corresponding opening 64 in the worm gear 58 are disposed about a center axis A. The configuration of the shaft 38 and the fit between the end portion 38b of the shaft 38 and the worm gear 58 will be discussed in greater detail below. The worm gear 58 is preferably adapted to cooperate with a gear 60 such that operation of the motor 30 will turn the output shaft 34 which drives the shaft 38. The shaft 38 then turns the worm gear 58 which in turn causes the gear 60 to also rotate. The gear 60 is positioned at one end of a threaded shaft 62 such that the shaft 62 is rotatably driven by the movement of the gear 60 and worm gear 58. An end cap 66 is preferably positioned at the end of the shaft 62 adjacent the gear 60 such that the gear 60 remains in a relatively fixed position relative to the housing 50 and worm gear 58. It is preferred that the transmission assembly 42 be adapted to cause the input shaft 38 to translate rotational power to a shaft 62 that is generally perpendicular to the input shaft 38. It will be appreciated that the transmission assembly 42 describe above is, in large measure, conventional in the art and is intended merely to illustrate one environment in which this invention may be used. Thus, the scope of this invention is not intended to be limited for use with the specific structure for the transmission assembly 42 illustrated in FIGS. 2 and 3. On the contrary, as will become apparent below, this invention may be used with any type of transmission assembly for the purposes described below.

The shafts 38, 40 of the present invention are shown in more detail in FIGS. 3 through 7. For simplicity, the individual shaft 38 will be described in detail, although it will be appreciated that the shaft 40 may be similarly configured for use in the transmission assembly 44 of the power seat adjuster 16. The shaft 38 is preferably formed from a flexible cable having a helical wound steel core surrounded by a protective outer covering or sheath. It will be appreciated, however, that the shaft 38 may be formed from any other suitable material or combination and configuration of materials. The shaft 38 may be formed using any suitable manufacturing method or combination of methods. The shaft 38 is comprised of a main shaft portion 38a and at least one end portion 38b. The main shaft portion 38a of the shaft 38 may have any suitable cross-sectional shape and size. Preferably, the main shaft portion 38a of the shaft 38 has a circular cross-section. The main shaft portion 38a is disposed about a main rotational axis D.

The shaft 38 also includes an end portion 38b. The end portion 38b of the shaft 38 cooperates with the worm gear 58 of the transmission 46. The end portion 38b includes a first portion 38c. The first portion 38c may have any suitable cross-sectional shape and size that is generally complementary to the cross-sectional shape of the socket opening 64 and allows the first portion 38c to cooperate with the opening 64. Preferably, the cross-section of the first portion 38c has a substantially uniform, polygonal shape. More preferably, the first portion 38c has a square cross-sectional shape. The first portion 38c is preferably tapered relative to the main shaft portion 38a, with the two sections 38a, 38c being connected by a tapered transition portion. The first portion 38c is disposed about a rotational axis B. Preferably, the rotational axis B of the first portion 38c is coaxial with the main rotational axis D of the main shaft portion 38a. The axes B and D of the first portion 38c and main shaft portion 38a, respectively, preferably axially align with the center axis A of the opening 64 of the worm gear 58. The alignment of the end portion 38b and the worm gear 58 will be discussed in greater detail below.

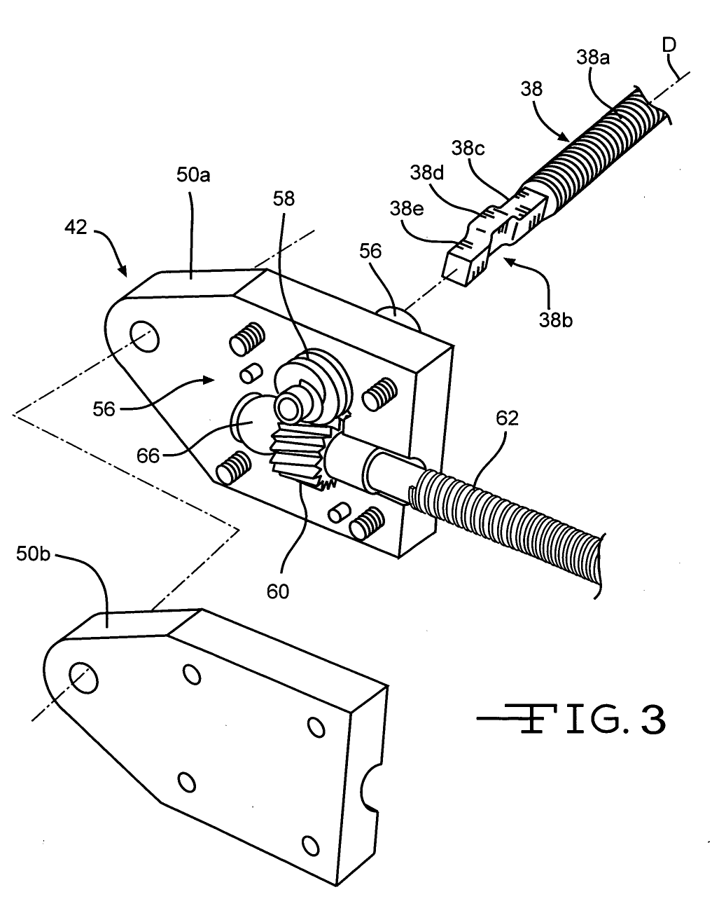

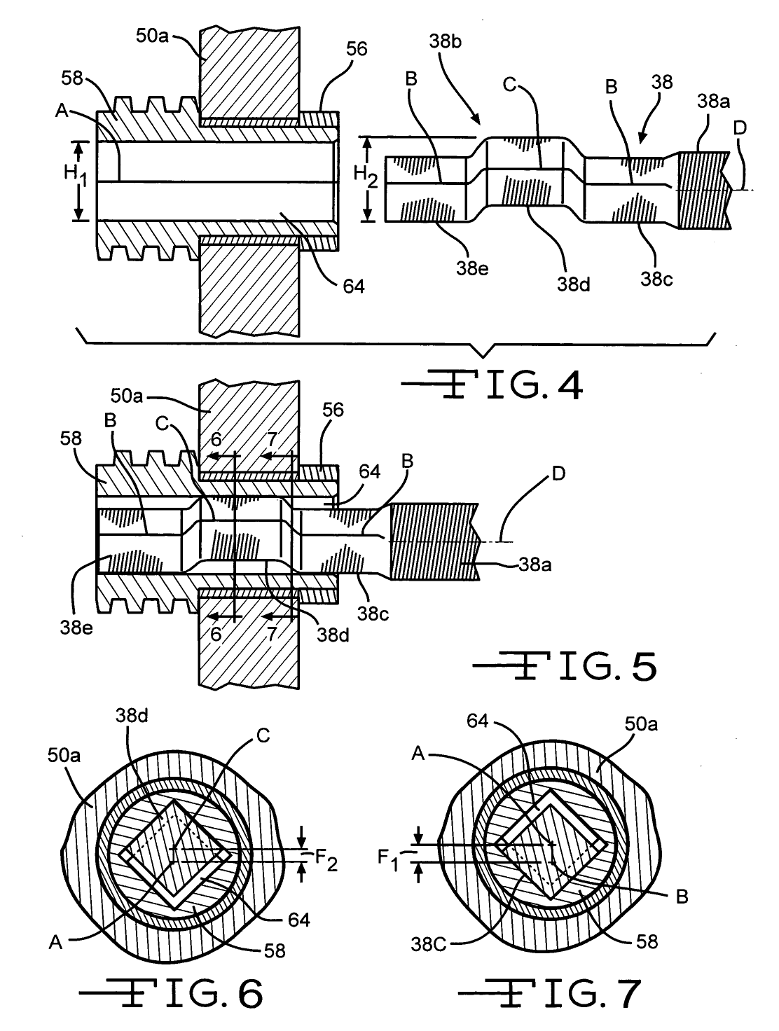

The end portion 38b includes a second portion 38d. The second portion 38d is connected to the first portion 38c, and is preferably integrally formed with the first portion 38c. Where the first portion 38c and second portion 38d are integrally formed, the transition between the two portions is preferably tapered, although such is not required. The second portion 38d preferably has a cross sectional shape that is similar to the cross sectional shape of the first portion 38c. It will be appreciated, however, that the second portion 38d may have any suitable cross-sectional shape and size that is generally complementary to the cross sectional shape of the socket opening 64 such that the second portion 38d can cooperate with the opening 64 when the end portion 38b is inserted into the opening 64. Preferably, the cross-section of the first portion 38c and the second portion 38d have a substantially uniform, polygonal shape. More preferably, the first portion 38c and the second portion 38d have a square cross-sectional shape. The second portion 38d is disposed about a rotational axis C. The axis C of the second portion 38d is axially offset from the rotational axis B of the first portion 38c, and subsequently is axially offset from the main rotational axis D of the main shaft portion 38a. The second portion 38d is axially offset from the first portion 38c such that the overall cross sectional height of the first portion 38c and second portion 38d, indicated by H₂ on FIG. 4, is preferably greater than or equal to the overall cross sectional height, indicated by H₁ on FIG. 4, of the opening 64 of the worm gear 58, thereby providing an interference fit. Additionally, where the cross section of the first portion 38c is square, a diagonal extending between the two opposite corners of the square is defined, and the second portion 38d is axially offset from the first portion 38c along that diagonal. The offset of the second portion 38d relative to the first portion 38c along the diagonal causes multiple adjacent faces of the square cross section of the second portion 38d to be axially offset relative to the first portion 38c. The fit of the end portion 38b within the opening 64 of the worm gear 58 will be discussed in greater detail below.

The end portion 38b of the shaft 38 may also include a third portion 38e. The third portion 38e is preferably integrally formed with the first portion 38c and second portion 38d. Where the third portion 38e is integrally formed, the transition between the second portion 38d and the third portion 38e is preferably tapered, although such is not required. The third portion 38e preferably has a cross sectional shape that is similar to the cross sectional shape of the first portion 38c. It will be appreciated, however, that the third portion 38e may have any suitable cross-sectional shape and size that is generally complementary to the cross-sectional shape of the socket opening 64 and allows the third portion 38e to cooperate with the opening 64. Preferably, the cross-section of the third portion 38e has a substantially uniform, polygonal shape. More preferably, the third portion 38e has a square cross-sectional shape. Where the end portion 38b includes a third portion 38e, preferably the first portion 38c is connected between the main shaft portion 38a and the second portion 38d, and the second portion 38d is disposed between the third portion 38e and the first portion 38c. The third portion 38e is preferably disposed about the same rotational axis B as the first portion 38c, and is preferably axially aligned with the first portion 38c. As discussed above, the rotational axis B of the first portion 38c and third portion 38e is preferably coaxial with the main rotational axis D of the main shaft portion 38a. The axes B and D of the first portion 38c, third portion 38e, and main shaft portion 38a, preferably axially align with the center axis A of the opening 64 of the worm gear 58. The alignment of the end portion 38b and the worm gear 58 will be discussed in greater detail below. Once again, where the cross section of the first portion 38c is square, a diagonal extending between the two opposite corners of the square is defined, and the second portion 38d is axially offset from the first portion 38c, and subsequently the third portion 38e, along that diagonal. The offset of the second portion 38d relative to the first portion 38c and the third portion 38e along the diagonal causes multiple adjacent faces of the square cross section of the second portion 38d to be axially offset relative to the first portion 38c and the third portion 38e.

The end portion 38b of the shaft 38 can be formed by any suitable method. Since the cross sectional areas of the first portion 38c, second portion 38d, and third portion 38e are preferably the same, the end portion 38b can be formed by a relatively simple stamping process, wherein the second portion 38d is stamped outwardly relative to the first portion 38c and third portion 38e of the end portion 38b. It will also be appreciated that the offset second portion 38d may be formed in the end portion 38b either during the initial forming of the end portion 38 or subsequent to the forming of the end portion 38b. Where the second portion 38d is formed subsequent to the initial forming of the end portion 38b, any suitable method may be used, such as stamping, crimping or die forming.

FIGS. 4 through 7 best illustrate the tight fit feature of the present invention. As discussed above, the end portion 38b includes a second portion 38d that is axially offset from the first portion 38c and third portion 38e of the end portion 38b. The second portion 38d is preferably situated between the first portion 38c and the third portion 38e of the end portion 38b, and may extend over any suitable length of the end portion 38b, and may also be situated at any suitable point along the length of the end portion 38b. Preferably, the second portion 38d accounts for approximately one-third of the length of the end portion 38b, and is disposed along the middle third of the end portion 38b. In a preferred embodiment, which is best illustrated by FIGS. 6 and 7, where the cross section of the first portion 38c is square, a diagonal extending between the two opposite corners of the square is defined, and the second portion 38d is axially offset from the first portion 38c, and subsequently the third portion 38e, along that diagonal. The offset of the second portion 38d relative to the first portion 38c and the third portion 38e along the diagonal causes multiple adjacent faces of the square cross section of the second portion 38d to be axially offset relative to the first portion 38c and the third portion 38e. These raised faces of the second portion 38d may be axially offset along the rotational axis C relative to the rotational axis B of the first portion 38c and the third portion 38e by any suitable amount. Preferably, the second portion is offset from the rotational axis B, and subsequently the main rotational axis A of the main shaft portion 38a, such that the overall height dimension H₂ of the cross section of the end portion 38b is greater than or equal to the overall height dimension H₁ of the opening 64 of the worm gear 58. This relationship of the overall height dimensions of the cross sections of the end portion 38b and the opening 64, H₂>H₁, creates a zero tolerance or interference fit between the opening 64 of the worm gear 58 and the end portion 38b when the end portion 38b is inserted into the opening 64 of the worm gear 58.

The purpose of the interference fit relationship between the opening 64 of the worm gear 58 and the end portion 38b is to create a slidable, yet non-rotatable, fit between the end portion 38b and the worm gear 58. The fit of the end portion 38b into the opening 64 of the worm gear 58 is best shown in FIGS. 5 through 7. The end portion 38b of the shaft 38 is positioned within the opening 64 of the worm gear 58 such that the offset faces of the second portion 38d interface with the complementary faces of the opening 64 of the worm gear 58. Similarly, faces of the first portion 38c and third portion 38e interface with the complementary faces of the opening 64 of the worm gear 58 as well. When the end portion 38b is inserted into the opening 64 of the worm gear 58, the main rotational axis D of the shaft 38, along with the rotational axis B of the first portion 38c and the third portion 38e (which is preferably axially aligned with axis D), are slightly offset from the center axis A of the opening 64 of the worm gear 58. The offset of the axes is denoted by F₁, shown in FIG. 7. Similarly, when the end portion 38b is inserted into the opening 64 of the worm gear 58, the center axis C of the axially offset second portion 38d is also slightly offset from the center axis A of the opening 64 of the worm gear 58. The offset of these axes is denoted by F₂, shown in FIG. 6. The cooperation of the surfaces of the various surfaces of the end portion 38b with the complementary faces of the opening 64, in conjunction with the axial misalignment of the various axes cause the planar surfaces of the various portions of the end portion 38b to remain in constant contact with the interior surfaces of the opening 64 in the worm gear 58. It is this interference fit relationship that helps to eliminate the noise and/or vibration at the interface of the end portion 38b and the opening 64 of the worm gear 58.

The principle and mode of operation of this invention have been described in its preferred embodiments. However, it should be noted that this invention may be practiced otherwise than as specifically illustrated and described without departing from its scope.

What is claimed is:

1. A shaft having an end adapted to be inserted in an opening of a socket for transmitting rotational forces between the shaft and the socket, said end comprising:
a first portion defining a first axis and having a predetermined first cross section generally complementary to the socket opening; and
a second portion connected to said first portion and having a second cross section similar to said first cross section, said second portion being axially offset from said first portion to cause an interference fit when said end is inserted in the socket opening.

2. The shaft of claim 1, wherein said first cross section is generally polygonal.

3. The shaft of claim 1, wherein said second portion is formed integrally with said first portion.

4. The shaft of claim 1, wherein the shaft includes a main shaft portion connected to said first portion and defining a main rotational axis coaxial with said first axis.

5. The shaft of claim 4, wherein said main shaft portion is flexible.

6. The shaft of claim 1, wherein the shaft includes a main shaft portion, wherein said first portion is connected between said second portion and said main shaft portion, and wherein said second portion is connected between said first portion and a third portion.

7. The shaft of claim 6, wherein said third portion has a third cross section similar to said first cross section, and is axially aligned with said first portion.

8. The shaft of claim 7, wherein said first predetermined cross section is square and defines a diagonal extending between the two opposite corners of the square, and wherein said second portion is axially offset from said first portion and said third portion along said diagonal.

9. The shaft of claim 7, wherein said main shaft portion defines a main rotational axis coaxial with said first axis.

10. The shaft of claim 9, wherein said main shaft portion is flexible.

11. The shaft of claim 9, wherein said first predetermined cross section is polygonal.

12. The shaft of claim 1, wherein said first predetermined cross section is square and defines a diagonal extending between the two opposite corners of the square, and wherein said second portion is axially offset from said first portion along said diagonal.

13. The shaft of claim 1, wherein said shaft and the socket are components of a transmission assembly for a power seat adjuster for a vehicle seat.

14. A vehicle power seat track adjuster comprising:
a first track;
a second track;
a motor;
a transmission drive that enables movement of said first track relative to said second track; and
a shaft for connecting said to said transmission drive block, said shaft having an end adapted to be inserted in an opening of a socket within said for transmitting rotational forces between said shaft and said socket, said end comprising a first portion defining a first axis and having a predetermined first cross section generally complementary to the socket opening, said end also comprising a second portion connected to said first portion and having a second cross section similar to said first cross section, said second portion being axially offset from said first portion to cause an interference fit when said end is inserted in the socket opening.
